(19) United States
(12) Patent Application Publication
(10) Pub. No.: US 2024/0135086 A1
(43) Pub. Date: Apr. 25, 2024

(54) SYSTEM AND METHOD FOR IDENTITY DATA SIMILARITY ANALYSIS

(71) Applicant: Semandex Networks, Inc., Princeton, NJ (US)

(72) Inventors: Ethan WOLKOFF, North Brunswick, NJ (US); Daniel J. REININGER, Skillman, NJ (US); Dhananjay D. MAKWANA, Lawrence Twp., NJ (US)

(73) Assignee: Semandex Networks, Inc., Princeton, NJ (US)

(21) Appl. No.: 17/973,279

(22) Filed: Oct. 24, 2022

(51) Int. Cl. G06F 40/12

(52) U.S. Cl. CPC G06F 40/12

(57) ABSTRACT

Techniques for identity data similarity analysis that generate high confidence matches are disclosed. In one particular embodiment, the techniques may be realized as a method comprising the steps of receiving identity data of an entity including a numerical value, converting the identity data to a textual representation of the numerical value, inserting the textual representation into a prose template, converting the prose template into a prose vector, and determining a similarity score based on the prose vector and a previously-identified prose vector.

### FIELD OF THE DISCLOSURE

The present disclosure relates generally to applications of Artificial Intelligence (AI) and Machine Learning (ML), and more particularly, to techniques for resolving entity identity data by automatically finding entities that are matching candidates for resolving multiple sets of identity data into a single entity.

### BACKGROUND OF THE DISCLOSURE

As the amount of data annually generated and stored by computers continues to grow, the amount of data associated with a particular entity can proliferate to substantial size and complexity. Annual worldwide data created is expected to about triple in size by the year 2025 compared to the size in 2020.

Identity resolution is a process of determining whether two different records describe a common entity. Identity data similarity analysis is needed to determine identity data records that are more likely to refer to the common entity (e.g., a person or an organization). Identity data can be categorical, descriptive or alpha-numerical. Examples of identity data for a person include names, aliases, date of birth, place of birth, occupations, citizenship, identity documents, whereabouts, kinship, close associates, affiliations, email addresses, phone numbers, skills, education, IP addresses, etc. Similarly, identity data for organizations include names, date of incorporation, place of incorporation, tax identification number(s), other identification numbers, officers, directors, and subsidiaries, etc.

Existing resolution techniques are generally categorized into two types: rule-based techniques and machine learning techniques. A problem with the rule-based resolution techniques is that they have high specificity at the expense of low sensitivity. The rule-based techniques are ill-equipped to handle new appearances of input data that were not manually accounted for, such as unintentional errors in data entry or different formats of a certain attribute. For example, a rule may account for an identity corresponding to a certain name and date-of-birth, but if the date-of-birth is in a format that was not accounted for, then an incorrect identity may be determined. Furthermore, these rule-based resolutions are not scalable.

Artificial Intelligence (AI) techniques may offer better flexibility and scalability of input data compared to rule-based techniques for determining similarity. For example, Natural Language Processing (NLP) may be used to process the textual values of identity data and to compare textual values for similarities. However, NLP techniques are not without drawbacks of their own. A problem with trying to identify data by assessing similarity via NLP, for example, is that word embeddings (i.e., vector representations) are not effective when applied to numbers and numerical values, which can contain critical information for identity data similarity analysis.

What is needed is a technique for identity data similarity analysis that enables effective application of NLP techniques to resolve identity data including numerical identifiers contained in the identity data.

### SUMMARY OF THE DISCLOSURE

Techniques for identity data similarity analysis that generate high confidence matches are disclosed. In one particular embodiment, the techniques may be realized as a system for identity data similarity analysis comprising an identity prose synthesizer for receiving identity data of an entity including a numerical value, converting the identity data to a textual representation of the numerical value, and inserting the textual representation into a prose template, an identity prose encoder for converting the prose template into a prose vector, and an identity prose similarity component for determining a similarity score based on the prose vector and a previously-identified prose vector.

In accordance with other aspects of this particular embodiment, the identity data may be a birth date.

In accordance with further aspects of this particular embodiment, the identity data may be a legal entity. In one example, the legal entity may be a person. In another example, the legal entity may be a company.

In accordance with additional aspects of this particular embodiment, the identity data may be an abbreviation of a country and the textual representation may be a full name of the country. In accordance with other aspects of this particular embodiment, the identity prose encoder may convert the prose template into the prose vector utilizing a sentence transformer model to generate text embeddings.

In accordance with further aspects of this particular embodiment, the sentence transformer model may be a multilingual sentence transformer model.

In accordance with other aspects of this particular embodiment, the identity prose similarity component may determine the similarity score by computing the cosine similarity of the prose vector and the previously-identified prose vector.

In accordance with other aspects of this particular embodiment, the identity prose similarity component may determine a plurality of matches to the identity data, each match of the plurality of matches including a similarity score.

In accordance with other aspects of this particular embodiment, the system may further comprise a candidate selection component for selecting a plurality of candidates from the plurality of matches based on the similarity score of each match of the plurality of matches.

In accordance with further aspects of this particular embodiment, the candidate selection component may normalize the similarity score of each match of the plurality of matches.

In accordance with additional aspects of this particular embodiment, the identity data may be an abbreviation of a country and the textual representation may be a full name of the country.

In accordance with further aspects of this particular embodiment, the system may further comprise a candidates down-selection component for selecting one or more of the plurality of candidates based on the prose template.

In accordance with additional aspects of this particular embodiment, the system may further comprise a candidates down-selection component for selecting one or more of the plurality of candidates based on additional entity information.

In accordance with other aspects of this particular embodiment, the identity prose synthesizer may incorporate a physical description including one or more of height, weight, eye color, complexion, and hair color, and a biographical association including one or more of a business ownership, one or more institutions attended, and one or more kinships, in narrative form.

In another particular embodiment, the techniques may be realized as a method for identity data similarity analysis comprising the steps of receiving identity data of an entity including a numerical value, converting the identity data to a textual representation of the numerical value, inserting the textual representation into a prose template, converting the prose template into a prose vector, and determining a similarity score based on the prose vector and a previously-identified prose vector.

In accordance with other aspects of this particular embodiment, the prose template may be converted into the prose vector utilizing a sentence transformer model to generate text embeddings. In accordance with further aspects of this particular embodiment, the sentence transformer model may be a multilingual sentence transformer model.

In accordance with other aspects of this particular embodiment, determining the similarity score may comprise computing the cosine similarity of the prose vector and the previously-identified prose vector.

In accordance with other aspects of this particular embodiment, the method may further comprise the step of determining a plurality of matches to the identity data, each match of the plurality of matches including a similarity score.

In accordance with further aspects of this particular embodiment, the method may further comprise the step of selecting a plurality of candidates from the plurality of matches based on the similarity score of each match of the plurality of matches.

In accordance with additional aspects of this particular embodiment, selecting the plurality of candidates may comprise normalizing the similarity score of each match of the plurality of matches.

In accordance with further aspects of this particular embodiment, the method may further comprise selecting one or more of the plurality of candidates based on the prose template.

In accordance with additional aspects of this particular embodiment, the method may further comprise selecting one or more of the plurality of candidates based on additional entity information.

In accordance with further aspects of this particular embodiment, the identity data may be a birth date.

In accordance with other aspects of this particular embodiment, the identity data may be a legal entity. In one example, the legal entity may be a person. In another example, the legal entity may be a company.

In accordance with other aspects of this particular embodiment, the identity data may be an abbreviation of a country and the textual representation may be a full name of the country.

In another particular embodiment, the techniques may be realized as at least one processor readable storage medium storing a computer program of instructions configured to be readable by at least one processor for instructing the at least one processor to execute a computer process for performing the method.

In another particular embodiment, the techniques may be realized as an article of manufacture for identity data similarity analysis, the article of manufacture comprising at least one processor readable storage medium, and instructions stored on the at least one medium. The instructions may be configured to be readable from the at least one medium by at least one processor and thereby cause the at least one processor to operate so as to receive identity data of an entity including a numerical value, convert the identity data to a textual representation of the numerical value, insert the textual representation into a prose template, convert the prose template into a prose vector, and determine a similarity score based on the prose vector and a previously-identified prose vector.

In accordance with other aspects of this particular embodiment, the instructions may be further configured to be readable from the at least one medium by at least one processor and thereby cause the at least one processor to operate so as to convert the prose template into the prose vector utilizing a sentence transformer model to generate text embeddings. In one example, the sentence transformer model may be a multilingual sentence transformer model.

In accordance with other aspects of this particular embodiment, the instructions may be further configured to be readable from the at least one medium by at least one processor and thereby cause the at least one processor to operate so as to determine a plurality of matches to the identity data, each match of the plurality of matches including a similarity score.

In accordance with further aspects of this particular embodiment, the instructions may be further configured to be readable from the at least one medium by at least one processor and thereby cause the at least one processor to operate so as to select a plurality of candidates from the plurality of matches based on the similarity score of each match of the plurality of matches.

In accordance with additional aspects of this particular embodiment, the instructions may be further configured to be readable from the at least one medium by at least one processor and thereby cause the at least one processor to operate so as to select one or more of the plurality of candidates based on the prose template.

In accordance with further aspects of this particular embodiment, the instructions may be further configured to be readable from the at least one medium by at least one processor and thereby cause the at least one processor to operate so as to select one or more of the plurality of candidates based on additional entity information. In one example of the article of manufacture, the identity data may be a birth date.

In accordance with other aspects of this particular embodiment, the identity data may be a legal entity. In one example, the legal entity may be a person. In another example, the legal entity may be a company.

In accordance with other aspects of this particular embodiment, the instructions may be further configured to be readable from the at least one medium by at least one processor and thereby cause the at least one processor to operate so as to determine the similarity score by computing the cosine similarity of the prose vector and the previously-identified prose vector.

In another particular embodiment, the techniques may be realized as a post-processor system for identity data similarity analysis comprising a corpus of additional identity data, a sentence encoder, and a semantic topic generator.

In accordance with other aspects of this particular embodiment, the sentence encoder may generate sentence embeddings via a multilingual sentence transformer model.

In accordance with other aspects of this particular embodiment, the sentence encoder may utilize a sentence transformer model to generate text embeddings.

In accordance with other aspects of this particular embodiment, the embeddings and the corpus may be utilized by the topic generator to group and label the topics.

In accordance with other aspects of this particular embodiment, highest scoring matches may be further discriminated through topic generation.

The present disclosure will now be described in more detail with reference to particular embodiments thereof as shown in the accompanying drawings. While the present disclosure is described below with reference to particular embodiments, it should be understood that the present disclosure is not limited thereto. Those of ordinary skill in the art having access to the teachings herein will recognize additional implementations, modifications, and embodiments, as well as other fields of use, which are within the scope of the present disclosure as described herein, and with respect to which the present disclosure may be of significant utility.

### BRIEF DESCRIPTION OF THE DRAWINGS

In order to facilitate a fuller understanding of the present disclosure, reference is now made to the accompanying drawings, in which like elements are referenced with like numerals. These drawings should not be construed as limiting the present disclosure, but are intended to be illustrative only.

FIG. 1 shows a block diagram of a system for identity data similarity analysis in accordance with an embodiment of the present disclosure.

FIG. 2 shows a method for identity data similarity analysis in accordance with an embodiment of the present disclosure.

### DETAILED DESCRIPTION OF EMBODIMENTS

Traditional resolution techniques rely on common attributes to resolve the common identity of two sets of data. In the context of identifying people, such attributes can include names and date-of-birth. However, a problem with using these attributes is that records can be inaccurate which leads to failed or inaccurate matching attempts. To compound the problem, modern data mining often has to deal with massive numbers of records describing entities, for example people and companies, in public and private data sources. These records may contain ambiguous, duplicate or incomplete identity data on those entities. Determining that two different sets of data both correspond to a common entity is a challenge that is solved by identity data similarity analysis methods and systems performing the same described herein.

For illustrative purposes, identity data is described herein with particular examples of identity data. Those skilled in the art would appreciate that the techniques disclosed herein may be applied to other types of identity data, as an alternative to or in addition of the particular examples provided.

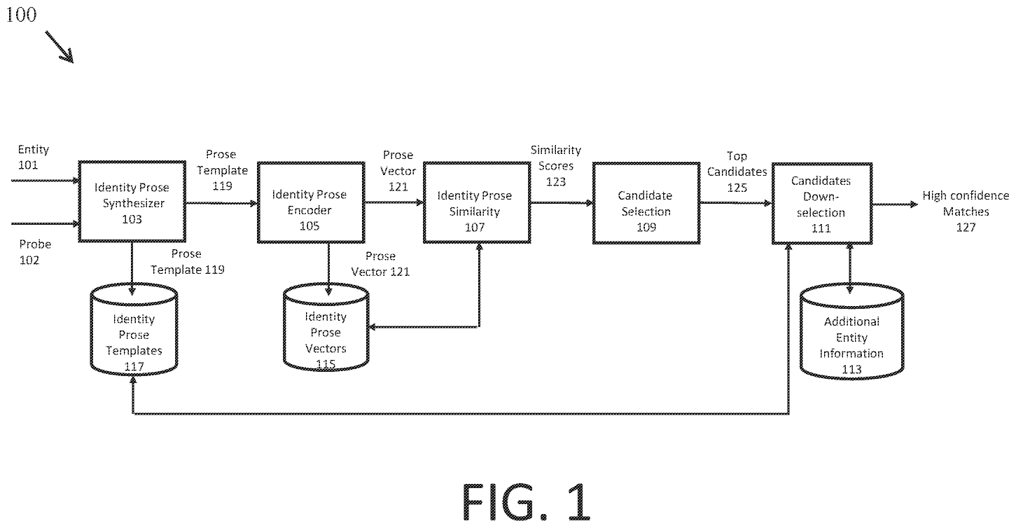

FIG. 1 shows a block diagram of an identity data similarity analysis system generally indicated at 100. In at least one embodiment, the system 100 is utilized with a method for identity data similarity analysis. The identity data similarity analysis applies to legal entities, such as companies and persons, and includes finding similarities among collections of identity data to determine if the entities represented are likely to be the same. There are numerous and diverse possible entities that can be resolved ranging from names, date-of-birth (DOB), place-of-birth (POB), citizenships and identity documents that provide contextual associations like kinship, close associates, affiliations, education, etc. The system 100 and the method for identity similarity data analysis cope with such a diversity of entities in a unified way by adding statements that capture the identity data into an identity template.

The system 100 receives entity records of two types: enrollments and search probes. Search probes are sent to the system 100 to find best matching enrollments—those that have the highest similarity.

The system 100 includes an identity prose synthesizer 103, an identity prose encoder 105, an identity prose similarity component 107, a candidate selection component 109, candidate down-selection component 111, additional entity information storage 113, identity prose vectors storage 115, and identity prose templates storage 117.

One or more enrollment entities 101 (e.g., a person, a company) and one or more search probe entities 102 (e.g., a paragraph of text including one or more sentences) are provided to the identity prose synthesizer 103. The identity prose synthesizer 103 creates and provides one or more prose templates 119 to the identity prose encoder 105 and to the identity prose templates storage 117. The prose templates 119 are also generated from known enrollment entities 101 to be used for candidate down-selection at a later point in time. The identity prose encoder 105 creates and provides one or more prose vectors 121 to the identity prose similarity component 107 and to the identity prose vectors storage 115. The identity prose similarity component 107 generates one or more similarity scores 123 that are received by the candidate selection component 109.

In at least one embodiment, the candidate selection component 109 refines the list of similarity scores 123 into one or more top similar candidates 125 by normalizing the similarity scores 123 and/or ranking the similarity scores 123 according to a potential match score threshold. The candidate selection component 109 provides the one or more top similar candidates 125 to the candidates down-selection component 111. The candidates down-selection component 111 is, in at least one example, a post-processor.

The candidates down-selection component 111 produces one or more high confidence matches 127. In some embodiments, the candidates down-selection component 111 receives, if available, data from the additional entity information storage 113. The high confidence matches 127 are produced, at least in some embodiments, by a combination of the top similar candidates 125 and additional entity information stored in the additional entity information storage 113. According to at least one embodiment, the candidates down-selection component 111 also retrieves prose templates for a given search probe entity 102 from the identity prose templates storage 117 to compare and contrast with the top similar candidates 125.

The identity prose synthesizer 103 converts each of the received enrollment entities 101 into prose form and generates a prose template 119 representation for the enrollment entities 101. A prose template 119 is, in at least one embodiment, text that follows a specific format. Once in the prose form, identity data is encoded using the identity prose encoder 105. Identity data includes in at least one example, data containing a number associated with an entity. In at least one embodiment, the prose template 119 includes the identity data and its associated prose. Encoded prose vectors generated from either an enrollment entity 101 or a search probe entity 102 are stored in the identity prose vector storage 115.

Prose vectors generated from identity data are compared to determine if any are close in vector space (i.e., similarity). The identity prose similarity component 107 computes the similarity scores 123 pair-wise between pose vectors, for example between the prose vector 121 and each of a plurality of prose vectors clustered by topic. In some examples, all of the prose vectors in the identity prose vectors storage 115 are compared to the prose vector 121. The data for a given match between a prose vector 121 and a stored prose vector some the identity prose vectors storage 115 is, in some examples, a triplet including the similarity score, an identifier for the entity of the prose vector 121 and an identifier for the stored vector used in the comparison.

When an entity probe search is input to the system 100 as a search probe entity 102, the identity prose similarity component 107 computes the similarity score of the vector form of the search probe entity 102 with respect to a number of other identity prose vectors stored in the identity prose vectors storage 115, and the candidate selection component 109 determines if there are any similar identities to the search probe entity 102 based on the prose vectors with highest similarity scores with respect to the search probe entity 102 (i.e., candidates).

The candidate selection component 109 generates the top similar identities candidates 125 and the candidates down selection component 111 generates the highest confidence matches 127 among all candidates. In certain embodiments, any stored additional entity information in the additional entity information storage 113, from available biographical datasets or any other data that contains descriptions and other characteristics of the entities, is used to further narrow down the similarity results and provide the highest confidence matches 127 to the search probe entity 102. The candidates down selection component 109 retrieves the identity prose templates 119 for the search probe entity 102 and its highest confidence matches and compares the prose templates 119 to highlight the differences as a form of explanation for the similarity score assigned.

The prose template 119 is synthesized via an understanding of what identity data elements are in the given set of identity data. The data is then converted to be readable within the context of the prose it is found in. The “understanding” referenced above, in at least one example, is based on the type of identity data present. If the identity data present contains a DOB, for example, the identity prose synthesizer 10 “understands” how to parse and convert the DOB data to a textual form. The same is true for a passport number, and addresses, and so forth. Embodiments of the system 100 and corresponding methods include using a series of regular expressions for a plurality of identity data types that build the prose template 119 by parsing and converting the prose template 119 to a sentence.

Once the identity data elements corresponding to identity records are converted to a prose template 119, they can be compared using Natural Language Processing (NLP) techniques that vectorize the text and compute a vector similarity metric between two vectorized records. In at least one example, the vector similarity metric is the cosine similarity between the two vectorized records and the two vectorized records are in floating point format.

A primary issue with trying to assess the similarity of identity data via NLP techniques is that those techniques are based on word embeddings that are not effective when applied to numbers and numerical values, which contain critical information for identity data similarity analysis. Embodiments described herein overcome this limitation and enable effective application of NLP techniques to identity data including numerical identifiers contained in identity data by converting the numbers to their textual representation.

Table 1 shows examples of original values of identity data and the values converted therefrom by the identity prose synthesizer 103 as well as the converted text being synthesized into the prose.

TABLE 1

| Original Value | Converted Value | In Prose |
|---|---|---|
| 1980 Feb. 11 | Nineteen-eighty two | John Doe was born in: |
| | eleven | Nineteen-eighty two |
| | | eleven |
| Q3121724 | Quebec three one two one | John Doe has been |
| | seven two four | associated with: |
| | | Quebec three one two |
| | | one seven two four |
| ru | Russia | John Doe has lived in: |
| | | Russia |

The following are three additional examples of synthesized prose outputs that could be created based on varying amounts of data:
1. This person's name is John Doe. The person also uses the aliases Johnny Dough and Jack Do. The person has used the following dates of birth: nineteen eighty-two February eleventh.
2. The person is associated with the following identifiers: Quebec three one two three seven zero five. This person has used the following email addresses: jdoe@person.com.
3. This person is associated with the following countries: Russia.

The first synthesized output presented above includes the output of “nineteen eighty-two February eleventh.” This output could have come from a numerical date and been generated according to common processing for DOBs in multiple formats. At least one embodiment includes libraries for normalizing numerical dates to a format of, for example, YYYY-MM-DD, and then the identity prose synthesizer 103 produces the corresponding textual format of the DOB.

The synthesized prose is used as a parameter, along with the sentence-transformer model in a “paraphrase mining” function, which returns the scores of the comparisons (e.g., the similarity scores 123), according to certain embodiments. These scores are then normalized by finding the minimum and maximum values to normalize out the narrative similarities. This is done by subtracting the minimum similarity score from the maximum similarity score, as well as from the score to normalize, and then performing a percentage calculation with the whole being the former, and the part being the latter. For example: if the minimum is 0.79, and the maximum is 1, and the score to normalize is 0.86, subtract 0.79 from 1 resulting in 0.21, and then subtract 0.79 from 0.86 giving 0.07, and then calculating the percentage 0.07 is of 0.21, giving 33.33%, which would be the normalized score.

Examples of search probe entities 102 and three candidate identity prose vectors retrieved from the identity prose vectors storage 115 are provided in Table 2 along with their respective similarity scores. Dissimilar portions of the identity prose vector of a known entity are underlined to facilitate comparison.

TABLE 2

| | | similarity |
|---|---|---|
| search probe entity | identity prose vector | score |
| This person's name is András | This person's name is András Tóth. | 97.9 |
| Tóth. The person also uses the | The person also uses the aliases | |
| aliases Andras Toth; Tóth András. | Andras Toth; Tóth András. The person | |
| The person has used the following | has used the following dates of birth: | |
| dates of birth: nineteen sixty-five | nineteen forty-six Sep eighteenth. This | |
| Dec ninth. This person is | person is associated with the following | |
| associated with the following | countries Hungary. The person 'as is | |
| countries Hungary. The person has | identified in the following ways: | |
| is identified in the following ways: | Quebec five one eight eight one one | |
| Quebec five one eight eight one | three three | |
| zero nine eight | | |
| This person's name is András | This person's name is Imre Tóth. The | 79.2 |
| Tóth. The person also uses the | person also uses the aliases Imre | |
| aliases Andras Toth; Tóth András. | Toth; Tóth Imre. The person | |
| The person has used the following | has used the following dates of birth: nineteen | |
| dates of birth: nineteen sixty-five | forty-six Apr eighteenth. This person | |
| Dec ninth. This person is | is associated with the following | |
| associated with the following | countries Hungary. The person has is | |
| countries Hungary. The person has | identified in the following ways: | |
| is identified in the following ways: | Quebec five one eight eight one zero | |
| Quebec five one eight eight one | nine six | |
| zero nine eight | | |
| This person's name is András | This person's name is István Tóth. The | 41.1 |
| Tóth. The person also uses the | person also uses the aliases Istvan | |
| aliases Andras Toth; Tóth András. | Toth; Tóth István. The person has used | |
| The person has used the following | the following dates of birth: nineteen | |
| dates of birth: nineteen sixty-five | fifty-one Apr eleventh. This person is | |
| Dec ninth. This person is | associated with the following countries | |
| associated with the following | Hungary. The person has is identified | |
| countries Hungary. The person has | in the following ways: Quebec five | |
| is identified in the following ways: | one eight eight two three five three. | |
| Quebec five one eight eight one | | |
| zero nine eight | | |

Identity databases often hold notes providing a narrative description of the entities that is helpful to further distinguish entities with similar identity data. That information is stored in the additional entity information storage 113. NLP techniques may facilitate extraction of keywords and perform topic clustering of the additional entity information to boost the confidence of matches and further refine the down-selected candidates compute keywords and topics for allowing further grouping of similar identities, for example people who have a particular personality trait, or a similar crime committed, into a single group.

The structure corresponding to the identity prose synthesizer 103, the identity prose encoder 105, the identity prose similarity component 107, the candidate selection component 109, and/or the candidates down-selection component, is, in at least some examples, a computer processor executing program code carrying out the functions/algorithm(s) described for the corresponding component or element of the system 100. In other examples, one or more of these elements is a program or collection of code that is to be executed by a computer or processor. The structure corresponding to the additional entity information storage 113, the identity prose vectors storage 115, and/or the identity prose templates storage 117 is, in at least some examples, one or more of a server, a cloud storage location, and a local storage (e.g., a hard drive or solid state drive on a desktop).

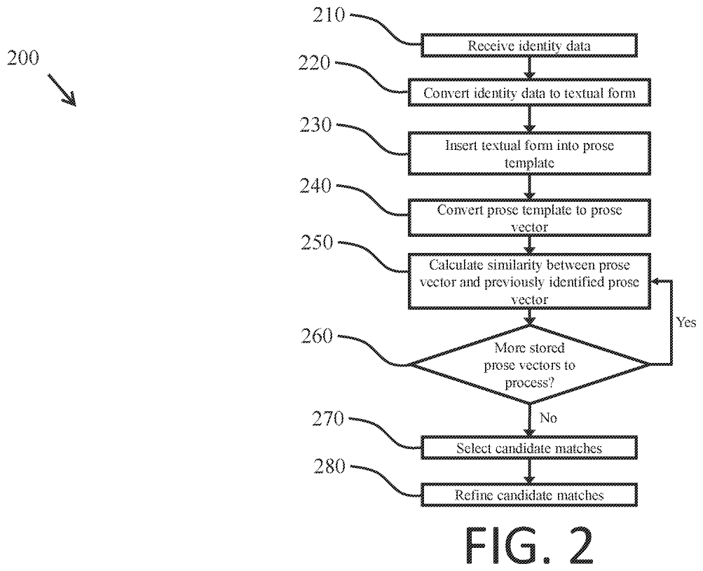

FIG. 2 shows a method for identity data similarity analysis 200 according to embodiments of the present disclosure. In at least one example, the method 200 is performed in the system 100. At block 210 identity data is received. The identity data may include prose entity records of two types: enrollments and search probes. Enrollments include known entity records that are processed and stored in a library or database of known identity prose templates for matching. Received search probes are input and processed to find matching enrolled entity records having a highest similarity.

According to at least one embodiment, the enrollments are provided in the form of a spreadsheet (e.g., CSV file) where each row is a set of identity data for a person. Each column of the spreadsheet includes one element of identity data, such as name, aliases, address, DOB, POB, passport record (issued by number), and so forth. The same set of enrollments can come from a database via an API (REST API if in the cloud, for example). A probe can be provided as a form in a user interface, where the user enters as many elements of the identity data of the probe as possible. The probe can also be provided from a picture of a driving license or passport over which optical character recognition (OCR) is performed.

At block 220, the identity data is converted to a textual representation of the numerical value. For example, the identity data may include prose in the form of two sentences. One of the two sentences is “The individual resides at 123 Main Street.” The number “123” is a numerical value. The numerical value is converted to its textual representation of “one twenty three.”

At block 230, the textual representation is inserted into a prose template. A prose template can be a text document or text in a data structure such a JSON document. A prose template is a narrative description of the identity data associated with an entity record. The prose template may be a collection of sentences where one or more of the numerical terms in the sentences is replaced by the textual representation. The prose vector may then be transferred to a storage (e.g., the identity prose templates storage 117). Keeping with the example above, the other of the two sentences is “He is an attorney.” Accordingly, the textual representation is inserted into the prose template as “The individual resides at one twenty three Main Street. He is an attorney.” The replaced numerical value has been emphasized.

At block 240, the prose template is converted into a prose vector. The prose template is converted into the prose vector utilizing a sentence transformer model to generate text embeddings. The sentence transformer model may be a multilingual sentence transformer model. In some examples, the prose vector is transferred to a storage (e.g., the identity prose vectors storage 115). At block 250, a similarity score of the prose vector is determined by comparing the prose vector to a previously-identified prose vector. The similarity score, in at least one embodiment, is determined by calculating the cosine similarity between the prose vector and the previously-identified prose vector. The higher the cosine value, the more similar the prose vector is to the previously-identified prose vector. The previously-identified prose vector may be associated with an enrollment entity 101 or an entity obtained from a different source. For example, the system 100 may obtain a prose vector from an external database separate from the identity prose vectors storage 115.

If there is a plurality of previously-identified prose vectors, a similarity score is calculated for each previously-identified prose vector (i.e., ‘Yes’ in a condition 260). Otherwise, if all the previously-identified prose vectors are processed and their similarity scores are calculated, the method 200 proceeds to block 270 (i.e., ‘No’ in the condition 260).

Once the similarity scores are calculated, at block 270, a list of the similarity scores is refined into one or more top similar candidates by normalizing the similarity scores and/or ranking the similarity scores according to a potential match score threshold. For example, only those similarity scores from the list above 0.85 are retained because each score is compared to a threshold of 0.85, where any score below 0.85 is not retained. A similarity score may be in the range between 0.00 and 1.00. According to certain examples, there may be rounding errors in the normalization that need to be accounted for. For example, some scores may be marginally above 1.00 (e.g., by 0000009) as understood by one of skill in the art.

At block 280, one or more of the top similar candidates are selected to further refine down and increase confidence that the resulting candidates share a common identity with the search probe. If available, additional entity information is used to boost the confidence of candidate matches and further refine the down-selected candidates. In some cases, biographical or descriptive information is available for person entities. An example of this additional entity information is: “This individual has three siblings, and two children. He plays soccer and basketball. He attended the University of Maryland. He owns a sail boat and rides a motorcycle.” An example for companies or legal entities is: “Company owns a minority stake in Acme Inc.”

A subset of the top candidates may be retained if it is determined that they share a common keyword or topic. Alternatively, or in addition to using the additional entity information, identity prose templates may be compared with the top similar candidates to determine if they match each other based on prose context, keywords, etc.

The method 200 may be implemented as program instructions stored in memory and executed by a computer processor or a plurality of processors. As part of a website accessible via a browser, for example, the method may be implemented by a remote server that is connected through the Internet or a local network to a computer or mobile device running the browser. The method 200 in at least one embodiment is run as a service on a cloud computer server accessible via an Application Programming Interface (API). The API implements endpoints to submit enrollment and probe entities. Embodiments include processor readable storage mediums, such as a hard disk or solid state drive, that store instructions for carrying out the steps of the method 200.

The present disclosure as described above may involve the processing of input data and the generation of output data to some extent. This input data processing and output data generation may be implemented in hardware or software. For example, specific electronic components may be employed in a desktop computer, server, cloud computing environment or similar or related circuitry for implementing the functions associated with the techniques described herein.

Alternatively, one or more processors (local and/or distributed) operating in accordance with instructions may implement the functions associated with identity data similarity analysis in accordance with the present disclosure as described above. If such is the case, it is within the scope of the present disclosure that such instructions may be stored on one or more non-transitory processor readable storage media (e.g., a magnetic disk or other storage medium), or transmitted to one or more processors via one or more signals embodied in one or more carrier waves. Storage can be distributed among one or several computer servers or use a cloud database service.

The present disclosure is not to be limited in scope by the specific embodiments described herein. Indeed, other various embodiments of and modifications to the present disclosure, in addition to those described herein, will be apparent to those of ordinary skill in the art from the foregoing description and accompanying drawings. Thus, such other embodiments and modifications are intended to fall within the scope of the present disclosure. Further, although the present disclosure has been described herein in the context of at least one particular implementation in at least one particular environment for at least one particular purpose, those of ordinary skill in the art will recognize that its usefulness is not limited thereto and that the present disclosure may be beneficially implemented in any number of environments for any number of purposes. Accordingly, the claims set forth below should be construed in view of the full breadth and spirit of the present disclosure as described herein.

1. A system for identity data similarity analysis, the system comprising:
an identity prose synthesizer for receiving identity data of an entity including a numerical value, converting the identity data to a textual representation of the numerical value, and inserting the textual representation into a prose template;
an identity prose encoder for converting the prose template into a prose vector; and
an identity prose similarity component for determining a similarity score based on the prose vector and a previously-identified prose vector.

2. The system of claim 1 wherein the identity prose encoder converts the prose template into the prose vector utilizing a sentence transformer model to generate text embeddings.

3. The system of claim 2 wherein the sentence transformer model is a multilingual sentence transformer model.

4. The system of claim 1 wherein the identity prose similarity component determines the similarity score by computing the cosine similarity of the prose vector and the previously-identified prose vector.

5. The system of claim 1 wherein the identity prose similarity component determines a plurality of matches to the identity data, each match of the plurality of matches including a similarity score.

6. The system of claim 1 further comprising a candidate selection component for selecting a plurality of candidates from the plurality of matches based on the similarity score of each match of the plurality of matches.

7. The system of claim 6 wherein the candidate selection component normalizes the similarity score of each match of the plurality of matches.

8. The system of claim 6 further comprising a candidates down-selection component for selecting one or more of the plurality of candidates based on the prose template.

9. The system of claim 6 further comprising a candidates down-selection component for selecting one or more of the plurality of candidates based on additional entity information.

10. A method for identity data similarity analysis comprising the steps of:
receiving identity data of an entity including a numerical value;
converting the identity data to a textual representation of the numerical value;
inserting the textual representation into a prose template;
converting the prose template into a prose vector; and
determining a similarity score based on the prose vector and a previously-identified prose vector.

11. The method of claim 10 wherein the prose template is converted into the prose vector utilizing a sentence transformer model to generate text embeddings.

12. The method of claim 11 wherein the sentence transformer model is a multilingual sentence transformer model.

13. The method of claim 10 wherein determining the similarity score comprises computing the cosine similarity of the prose vector and the previously-identified prose vector.

14. The method of claim 10 further comprising the step of determining a plurality of matches to the identity data, each match of the plurality of matches including a similarity score.

15. The method of claim 10 further comprising the step of selecting a plurality of candidates from the plurality of matches based on the similarity score of each match of the plurality of matches.

16. The method of claim 15 wherein selecting the plurality of candidates comprises normalizing the similarity score of each match of the plurality of matches.

17. The method of claim 15 further comprising the step of selecting one or more of the plurality of candidates based on the prose template.

18. The method of claim 15 further comprising the step of selecting one or more of the plurality of candidates based on additional entity information.

19. At least one processor readable storage medium storing a computer program of instructions configured to be readable by at least one processor for instructing the at least one processor to execute a computer process for performing the method as recited in claim 10.

20. An article of manufacture for identity data similarity analysis, the article of manufacture comprising:
at least one processor readable storage medium; and
instructions stored on the at least one medium;
wherein the instructions are configured to be readable from the at least one medium by at least one processor and thereby cause the at least one processor to operate so as to:
receive identity data of an entity including a numerical value;
convert the identity data to a textual representation of the numerical value;
insert the textual representation into a prose template;
convert the prose template into a prose vector; and
determine a similarity score based on the prose vector and a previously-identified prose vector.
